(19) United States
(12) Patent Application Publication
(10) Pub. No.: US 2010/0026617 A1
(43) Pub. Date: Feb. 4, 2010

(54) METHOD AND DEVICE FOR ACTIVATING SCAN LINES OF A PASSIVE MATRIX LIQUID CRYSTAL DISPLAY (LCD) PANEL

(75) Inventors: Chun-Neng Su, Taipei City (TW); Hung-Chi Weng, Taipei City (TW); Cheng-Che Ho, Taipei City (TW)

Correspondence Address: CHOATE, HALL & STEWART LLP, TWO INTERNATIONAL PLACE, BOSTON, MA, 02110, US

(73) Assignee: Integrated Solutions Technology, Inc., Taipei (TW)

(21) Appl. No.: 12/338,076

(22) Filed: Dec. 18, 2008

(30) Foreign Application Priority Data
Aug. 1, 2008 (TW) 097129240

(51) Int. Cl. G09G 3/36

(52) U.S. Cl. 345/98

(57) ABSTRACT

A method for activating scan lines of a passive matrix liquid crystal display (LCD) panel includes activating the scan lines of the passive matrix LCD panel in a selected one of an interlaced scanning mode and a progressive scanning mode that is selected based on a select signal. A device that performs the method is also disclosed.

### CROSS-REFERENCE TO RELATED APPLICATION

This application claims priority of Taiwanese application no. 097129240, filed on Aug. 1, 2008, which is incorporated herein by reference in its entirety.

### BACKGROUND OF THE INVENTION

1. Field of the Invention

This invention relates to a method and device for activating scan lines of a matrix liquid crystal display (LCD) panel, more particularly to a method and device for activating scan lines of a passive matrix LCD panel.

2. Description of the Related Art

Liquid crystal displays (LCD) are well known in the art and may be of the twisted nematic (TN) type, the super-twisted nematic (STN) type, and the thin film transistor (TFT) type.

FIG. 1 illustrates a conventional STN LCD that includes a panel 92 and a driving device 91. The panel 92 includes a plurality of scan lines (Com1 to ComN). The driving device 91 is connected to the scan lines (Com1 to ComN) of the panel 92.

The aforementioned conventional STN LCD is disadvantageous in that the driving device 91 activates the scan lines (Com1 to ComN) of the panel 92 only in a progressive scanning mode. This easily arises in crosstalk between an adjacent pair of the scan lines (Com1. to ComN), e.g., the scan lines (Com1 and Com2), and results in a shadow appearing in adjacent lines displayed on the conventional STN LCD. Such problem is even more apparent when the image contains adjacent black and white lines.

Furthermore, when displaying alternating black and white lines in a frame on the conventional STN LCD, since the scan lines (Com1 to ComN), are activated in the progressive scanning mode, a display-driving unit (not shown) is required to drive the panel 92 with a voltage that repeatedly switches between minimum and maximum levels. As such, the conventional STN LCD that operates in the progressive scanning mode consumes a relatively large amount of power.

### SUMMARY OF THE INVENTION

Therefore, an object of the present invention is to provide a method for activating scan lines of a passive matrix liquid crystal display (LCD) panel that can overcome the aforesaid drawbacks of the prior art.

Another object of the present invention is to provide a device for activating scan lines of a passive matrix LCD panel that can overcome the aforesaid drawbacks of the prior art.

According to an aspect of the present invention, a method for activating scan lines of a passive matrix LCD panel comprises activating the scan lines of the passive matrix LCD panel in a selected one of an interlaced scanning mode and a progressive scanning mode that is selected based on a select signal.

According to another aspect of the present invention, a method for activating scan lines of a passive matrix LCD panel comprises activating the scan lines of the passive matrix LCD panel in an interlaced scanning mode.

According to yet another aspect of the present invention, a device for activating scan lines of a passive matrix LCD panel comprises an activating unit and a controlling unit. The activating unit is adapted to be coupled to the scan lines of the passive matrix LCD panel and is operable so as to activate the scan lines of the passive matrix LCD panel. The controlling unit is coupled to the activating unit, is adapted to receive a select signal, and enables the activating unit to activate the scan lines of the passive matrix LCD panel in a selected one of an interlaced scanning mode and a progressive scanning mode that is selected based on the select signal received thereby.

### BRIEF DESCRIPTION OF THE DRAWINGS

Other features and advantages of the present invention will become apparent in the following detailed description with reference to the accompanying drawings, of which:

FIG. 1 is a block diagram illustrating a panel and a driving device of a conventional super-twisted nematic (STN) liquid crystal display (LCD);

FIG. 2 is a block diagram of an embodiment of a device connected to scan lines of a passive matrix LCD panel according to this invention;

FIG. 3 is a block diagram illustrating components of an embodiment of the device; and

FIG. 4 is a timing diagram illustrating an embodiment of activation of the scan lines of the passive matrix LCD panel in an interlaced scanning mode and a progressive scanning mode.

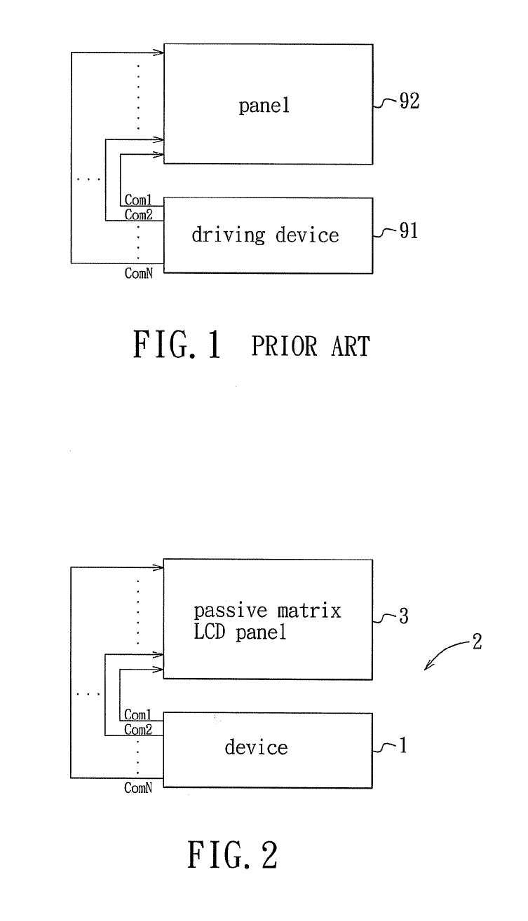

### DETAILED DESCRIPTION

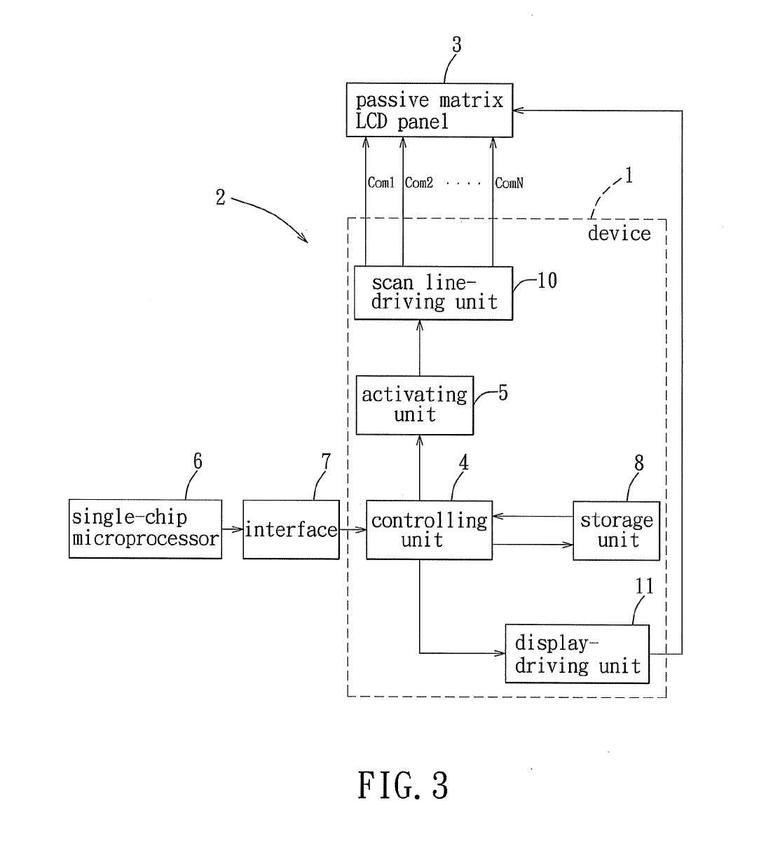

Referring to FIGS. 2 and 3, embodiments of a device 1 for a liquid crystal display (LCD) 2 according to this invention is shown to include an activating unit 5 and a controlling unit 4.

The device 1, such as a driving device, of this invention activates scan lines (Cora1 to ComN) of a passive matrix LCD panel 3 of the LCD 2, in a manner that will be described hereinafter.

In this embodiment, the LCD 2 may be a twisted nematic (TN) LCD or a super-twisted nematic (STN) LCD.

The activating unit 5 is connected to the scan lines (Cora1 to ComN) of the passive matrix LCD panel 3 through a scan line-driving unit 10, and is operable so as to generate scanning signals that serve to activate the scan lines (Com1 to ComN) of the passive matrix LCD panel 3. In this embodiment, the activating unit 5 is operable so as to activate the scan lines (Com1 to ComN) of the passive matrix LCD panel 3 in one of an interlaced scanning mode and a progressive scanning mode to display a frame on the passive matrix LCD panel 3.

The controlling unit 4 is connected to the activating unit 5, receives a select signal, and enables the activating unit 5 to activate the scan lines (Com1 to ComN) of the passive matrix LCD panel 3 in a selected one of the interlaced scanning mode and the progressive scanning mode that is selected based on the select signal received thereby.

In this embodiment, the select signal may be one that causes the controlling unit 4 to enable the activating unit 5 such that the scan lines (Com1 to ComN) are repeatedly activated in the progressive scanning mode to display frames on the passive matrix LCD panel 3. Moreover, in this embodiment, the select signal may be one that causes the controlling unit 4 to enable the activating unit 5 such that the scan lines (Com1 to ComN) are repeatedly activated in the interlaced scanning mode to display frames on the passive matrix LCD panel 3. Further, in this embodiment, the select signal may be one that causes the controlling unit 4 to enable the activating unit 5 such that the scan lines (Com1 to ComN) are alternately activated in the interlaced scanning mode and the progressive scanning mode to display frames on the passive matrix LCD panel 3.

The scan line-driving unit 10 is operable so as to convert a voltage level of an activating signal generated by the activating unit 5 into another voltage level, which is able to activate the scan lines (Com1 to ComN) of the passive matrix LCD panel 3.

The controlling unit 4 is further connected to a single-chip microprocessor 6, such as an 8051-series single-chip microprocessor, through an interface 7. The single-chip microprocessor 6 is operable so as to generate the select signal. The interface 7 is operable so as to convert a voltage level of the select signal generated by the single-chip microprocessor 6 to a voltage level required by the controlling unit 4.

The device 1 further includes a storage unit 8 and a display-driving unit 11. The storage unit 8 is connected to the controlling unit 4, and serves to store a plurality of pieces of display information therein. In this embodiment, the storage unit 8 may be a computer memory, such as a random access memory (RAM). Moreover, in this embodiment, the controlling unit 4 is further operable so as to generate a location address (LAD), and so as to retrieve the display information, which corresponds to an activated one of the scan lines (Com1 to ComN) of the passive matrix LCD panel 3, from a memory location, which is identified by the LAD generated thereby, in the storage unit 8. The display-driving unit 11 is connected to the controlling unit 4 and the passive matrix LCD panel 3, and is operable so as to drive the passive matrix LCD panel 3 with a voltage that corresponds to a scale of the display information retrieved by the controlling unit 4 to display image pixels on the passive matrix LCD panel 3.

The number of addressable memory locations in the storage unit B is equal to or greater than the number of the scan lines (Com1 to ComN) of the passive matrix LCD panel 3. As such, the storage unit B is able to store display information for each of the scan lines (Com1 to ComN) of the passive matrix LCD panel 3.

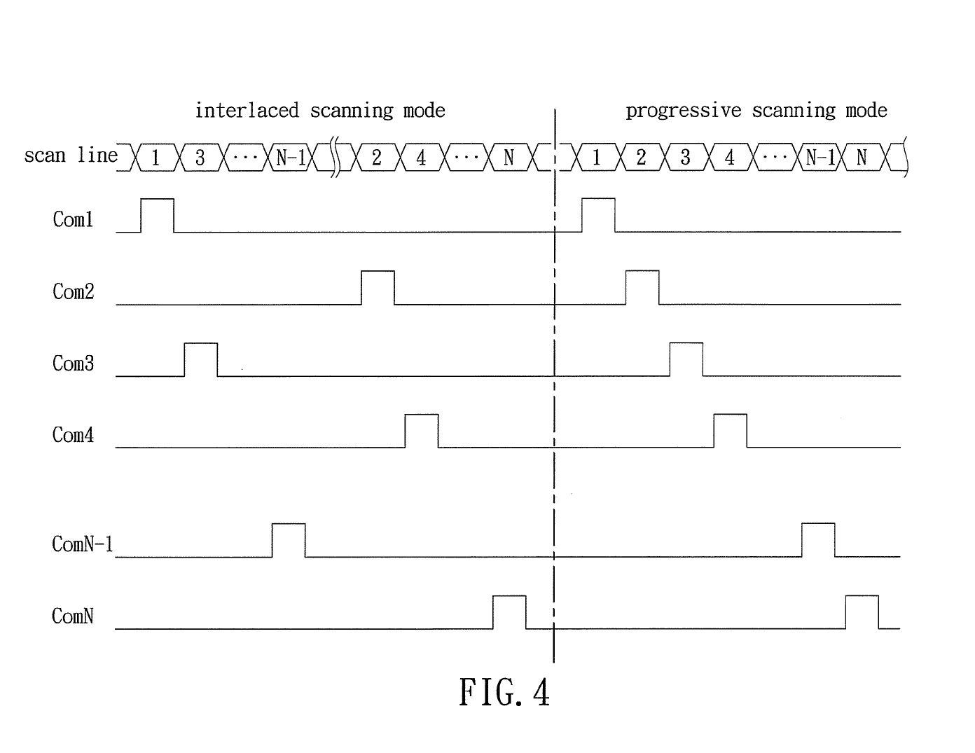

It is noted that, in the progressive scanning mode, as shown in FIG. 4, the activating unit 5 activates the scan lines (Com1 to ComN) in a consecutive manner. As such, in this mode, the aforementioned problems associated with the prior art may occur.

Furthermore, in the interlaced scanning mode, as shown in FIG. 4, the activating unit 5 activates first the odd-numbered scan lines (Com1, Com3 . . . ComN) in a consecutive manner, and then the even-numbered scan lines (Com2, Com4 . . . ComN−1) also in a consecutive manner. As such, in this mode, the aforementioned problems associated with the prior art are eliminated. That is, adjacent pairs of the scan lines (Com1 to ComN), e.g., the scan lines (Com1 and Com2), are not activated consecutively, thus preventing crosstalk. Also, when displaying alternating black and white lines in a frame on the passive matrix LCD panel 3, the display-driving unit 11 is not required to drive the passive matrix LCD panel 3 with a voltage that switches repeatedly between minimum and maximum levels, thereby lowering power consumption.

In another embodiment, in the interlaced scanning mode, the activating unit 5 may activate first the even-numbered scan lines (Com2, Com4 . . . ComN−1) in a consecutive manner, followed by the odd-numbered scan lines (Com1, Com3 . . . ComN) also in a consecutive manner.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for activating scan lines of a passive matrix liquid crystal display (LCD) panel, comprising:
activating the scan lines of the passive matrix LCD panel in a selected one of an interlaced scanning mode and a progressive scanning mode that is selected based on a select signal.

2. The method as claimed in claim 1, wherein the select signal enables repeated activation of the scan lines in the interlaced scanning mode to display frames on the passive matrix LCD panel.

3. The method as claimed in claim 1, wherein the select signal enables alternating activation of the scan lines in the interlaced scanning mode and the progressive scanning mode to display frames on the passive matrix LCD panel.

4. A method for activating scan lines of a passive matrix LCD panel, comprising:
activating the scan lines of the passive matrix LCD panel in an interlaced scanning mode.

5. A device for activating scan lines of a passive matrix LCD panel, comprising:
an activating unit adapted to be coupled to the scan lines of the passive matrix LCD panel and operable so as to activate the scan lines of the passive matrix LCD panel; and
a controlling unit coupled to said activating unit, adapted to receive a select signal, and enabling said activating unit to activate the scan lines of the passive matrix LCD panel in a selected one of an interlaced scanning mode and a progressive scanning mode that is selected based on the select signal received thereby.

6. The device as claimed in claim 5, wherein said controlling unit is responsive to the select signal to enable said activating unit such that the scan lines are repeatedly activated in the interlaced scanning mode to display frames on the passive matrix LCD panel.

7. The device as claimed in claim 5, wherein said controlling unit is responsive to the select signal to enable said activating unit such that the scan lines are alternately activated in the interlaced scanning mode and the progressive scanning mode to display frames on the passive matrix LCD panel.

8. The device as claimed in claim 5, further comprising:
a storage unit coupled to said controlling unit and storing a plurality of pieces of display information therein, said controlling unit being further operable so as to retrieve the display information from said storage unit that corresponds to an activated one of the scan lines; and
a display-driving unit coupled to said controlling unit, adapted to be coupled to the passive matrix LCD panel, and operable so as to drive the passive matrix LCD panel based on the display information retrieved by said controlling unit to display image pixels on the passive matrix LCD panel.
